(19) United States
(12) Patent Application Publication
(10) Pub. No.: US 2008/0291230 A1
(43) Pub. Date: Nov. 27, 2008

(54) IMAGE FORMING APPARATUS HAVING A MISSING NOZZLE DETECTION UNIT

(75) Inventor: Gu-hwan NA, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/876,973

(22) Filed: Oct. 23, 2007

(30) Foreign Application Priority Data
May 23, 2007 (KR) 2007-50269

(51) Int. Cl. B41J 29/38

(52) U.S. Cl. 347/12

(57) ABSTRACT

An image forming apparatus including an image printing unit formed above a printing path along which an image is formed on a print medium. The printing unit has an array inkjet printhead with a length corresponding to the width of a print medium and includes a plurality of nozzles to eject ink. The multi-functional device also includes an image scanning unit formed above the image printing unit with a scanning unit formed on a document reading path to transfer a document to scan and read the document and a missing nozzle detection unit which forms a missing nozzle detection path that connects the printing path and the document reading path, and transports a print medium on which a test image is formed by the array inkjet printhead, to the document reading path via the missing nozzle detection path to scan the test image using the scanning unit. The image scanning unit and the missing nozzle detection unit also share the scanning unit.

### CROSS-REFERENCE TO RELATED APPLICATIONS

This application claims the benefit under 35 U.S.C. §119(a) of Korean Patent Application No. 10-2007-0050269, filed on May 23, 2007 in the Korean Intellectual Property Office, the disclosure of which is incorporated herein in its entirety by reference.

### BACKGROUND OF THE INVENTION

1. Field of the Invention

The present general inventive concept relates to an image forming apparatus, such as a multi-functional peripheral device, and more particularly, to a multi-functional peripheral device including a missing nozzle detection unit that can detect a printing-failure region of an array inkjet printhead.

2. Description of the Related Art

In general, an inkjet image forming apparatus forms images on a print medium by ejecting ink from a printhead which moves backward and forward in a direction perpendicular to a moving direction of a print medium, that is, in the width direction of the print medium. Such a printhead is generally referred to as a shuttle type printhead.

Recently, to provide high speed printing, an array inkjet printhead having a nozzle unit with a length corresponding to the width of a print medium has been suggested instead of the printhead that moves backward and forward in the width direction of the print medium. In an inkjet image forming apparatus operated in this manner, an array inkjet printhead is fixed and only the print medium moves. Accordingly, a driving device that drives the inkjet printhead of the inkjet image forming apparatus is simple and high speed printing can be realized.

However, in the inkjet image forming apparatus that includes the array inkjet printhead, since the array inkjet printhead is fixed and has a size corresponding to the width of the print medium, if there is a defect in a nozzle of the fixed printhead, a portion of an image corresponding to the nozzle including the defect cannot be formed.

In order to solve the problems caused by the nozzle defect, the image forming apparatus is automatically corrected or the nozzle including the defect is changed with another neighboring nozzle.

However, before solving the problems caused by the nozzle defect, it is necessary to detect which one of the nozzles of the array inkjet printhead is defective.

Thus, the inkjet image forming apparatus including the array inkjet printhead needs to have a missing nozzle detection unit to detect nozzles including defects.

### SUMMARY OF THE INVENTION

The present general inventive concept provides a multi-functional peripheral device including a missing nozzle detection unit of an array inkjet printhead to detect nozzles including defects.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may also be achieved by providing an image forming apparatus including an image forming unit formed above a printing path along which an image is formed on a print medium, including a plurality of nozzles to eject ink, an image scanning unit formed adjacent the image forming unit and having a scanning unit formed on a document reading path transferring the document to read the document, and a missing nozzle detection unit including a missing nozzle detection path that connects the printing path and the document reading path, and transports a print medium, on which a test image is formed by the image forming unit, to the document reading path via the missing nozzle detection path to scan the test image using the image scanning unit, wherein the image scanning unit and the missing nozzle detection unit share the scanning unit.

The foregoing and/or other aspects and utilities of the present general inventive concept may also be achieved by providing an image forming apparatus including an image forming unit including a plurality of nozzles to eject ink to form a test image on a print medium according to data corresponding to a desired image, an image scanning unit having a scanning unit to scan one or more documents including the print medium, and a missing nozzle detection unit disposed between the image printing unit and the image scanning unit to feed the print medium to the image scanning unit to scan the test image from the print medium.

The image forming apparatus may further include a controlling unit to compare the test image with the data corresponding to the desired image to detect a defective one of the plurality of nozzles.

The controlling unit may further performs a correction operation to the corresponding defective one of the plurality of nozzles.

The image forming apparatus may further include a rotatable guide unit and rotatable first and second transporting rollers to guide the print medium toward the plurality of nozzles in a first direction to form a test image thereon.

The second transporting roller and the guide unit may further rotate in a second direction to guide the print medium with the test image formed thereon in a second direction towards a missing nozzle detection path of the missing nozzle detection unit.

The second transporting roller may further align the print medium according to the missing nozzle detection path to transport the print medium along the missing nozzle detection path.

The missing nozzle detection path may further include a second group of transporting rollers formed thereon to transport the print medium with a test image formed thereon towards the scanning unit to scan the print medium with the test image formed thereon.

The image scanning unit and the nozzle detection unit may share the same scanning unit.

The image scanning unit may include a first group of transporting rollers to transport the plurality of documents one by one along a document reading path to be scanned by the scanning unit.

The first group of transporting rollers may be formed along the document reading path and the second group of transporting rollers may be formed along the missing nozzle detection path. Additionally, the first group of transporting rollers and the second group of transporting rollers may be simultaneously actuated by a driving source.

A first end of the missing nozzle detection path may connect to the document reading path and a second end of the missing nozzle detection path may be disposed near the guide unit.

The image scanning unit may further include a glass panel disposed above the scanning unit and a pressing unit disposed above the glass panel. Additionally, the first group of transporting rollers may transport the plurality of documents one by one onto the glass panel and accordingly the pressing unit secures each of the documents to the glass panel when the document is scanned by the scanning unit.

The first group of transporting rollers may be meshed with a driving gear and the driving gear may be meshed with the driving source via a first intermediate gear.

The second group of transporting rollers may be meshed with the driving gear and the driving gear may be meshed with the driving source via a second intermediate gear.

When the driving source is actuated, the first group of transporting rollers may be rotated to transport the one or more documents along the document reading path, and the second group of transporting rollers may be rotated to transport the print medium with a test image formed thereon along the missing nozzle detection path.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view illustrating an image forming apparatus such as a multi-functional peripheral device according to an embodiment of the present general inventive concept;

FIG. 2 illustrates a driving relationship of transporting rollers of the multi-functional device illustrated in FIG. 1; and

FIGS. 3 through 5 illustrate a reading operation of a test image using the missing nozzle detect unit of the multi-functional peripheral device illustrated in FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

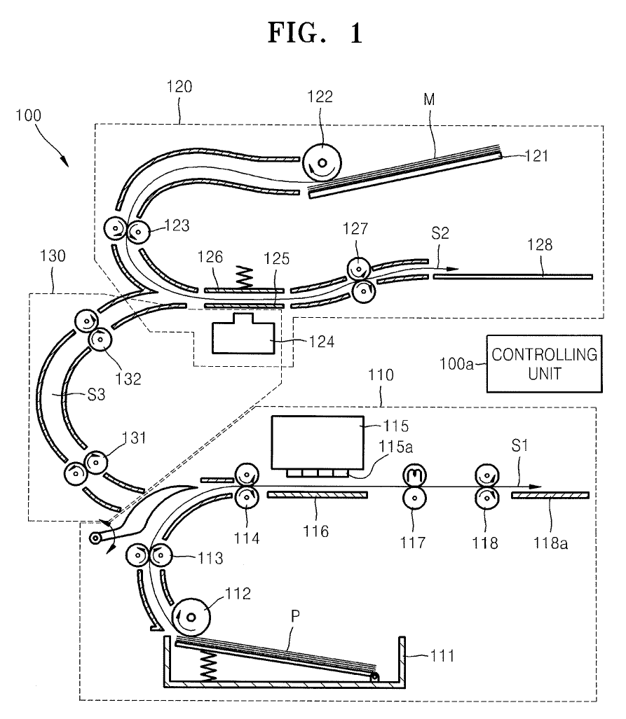

FIG. 1 is a view illustrating a multi-functional peripheral device 100 according to an embodiment of the present general inventive concept.

Referring to FIG. 1, the multi-functional peripheral device 100 includes an image printing unit 110 to print images, an image scanning unit 120 which is formed above the image printing unit 110 to read documents, and a missing nozzle detection unit 130 which is formed between the image printing unit 110 and the image scanning unit 120 and which scans a print medium on which test images are formed.

The image printing unit 110 forms an image on a print medium P, and includes a cassette 111, a plurality of transporting rollers 113 and 114, an array inkjet printhead 115 having a plurality of nozzles 115a, a fusing unit 117, and a discharge roller 118 all being located sequentially (i.e. consecutively) along a printing path S1.

The cassette 111 loads a plurality of print media P, and a pickup roller 112 which picks up the print media P sheet by sheet, is installed above the cassette 111.

The transporting rollers 113 and 114 transport the print medium P that is picked up by the pickup roller 112 along the printing path S1 and guide the print medium P toward the array inkjet printhead 115. The transporting roller 114 may further have a registration function of aligning the print medium P with respect to the printing path S1, prior to transporting the print medium P along the printing path S1. For instance, after the print medium P is guided toward the array inkjet printhead 115 and a test image T representing data responsive to a desired image is formed on the print medium P by the array inkjet printhead 115, the registration function of the transporting roller 114 may preferably rotate the print medium P clockwise or counter clockwise in order to successfully transport the print medium P on which the test image T is printed toward a missing nozzle detection path S3 of the missing nozzle detection unit 130, which will be described in further detail below.

The array inkjet printhead 115 has a length corresponding to the width of the print medium P, and includes a plurality of nozzles 115a to eject ink. A supporting plate 116 to support the print medium P is formed below the array inkjet printhead 115. The array inkjet printhead 115 is fixed, and as the print medium P passes below the array inkjet printhead 115, an image is formed on the print medium P by the ink ejected from the plurality of nozzles 115a.

The fusing unit 117 fuses (i.e. fixes) an image formed by the plurality of nozzles to the print medium P by applying heat and pressure to the image. In particular, the fusing unit 117 includes a heating roller and a pressurizing roller facing that contact each other, and as the print medium P passes from the array inkjet 115 along the printing path S1 through the fusing unit 117, a combination of heat and pressure is applied to the print medium P that fixes the image to the print medium P. The discharge roller 118 discharges the print medium P which has passed through the fusing unit 117 to the outside of the image printing unit and loads the print medium P to a discharge plate 118a.

The image scanning unit 110 further includes a rotatable guide unit 119 that rotates clockwise to direct the print medium toward array inkjet printhead 115 and after a test image T is formed by the array inkjet printhead 115 on the print medium P, the guide unit rotates counter-clockwise to guide the print medium P on which a test image T is formed to the missing nozzle detection unit 130. The following embodiment is but one example of the rotatable functionality of the guide unit. Accordingly, the guide unit may rotate in opposing directions to that as describe above.

The image scanning unit 120 reads a document M and includes a document loading plate 121, first transporting rollers 123, a scanning unit 124, second transporting rollers 127, and a document discharge plate 128 all being located sequentially along a document reading path S2.

The document loading plate 121 loads a plurality of documents M and a pickup roller 122 that picks up the documents M one by one, is disposed above the document loading plate 121. The first transporting rollers 123 are formed of a pair of rollers contacting and facing each other, and are disposed between the document loading plate 121 and the scanning unit 124 to transport the document M that is picked up by the pickup roller 122 in a direction toward the scanning unit 124.

The first transporting rollers 123 transport the document M onto a glass panel 125 whereby the scanning unit 124 scans and reads the document M. The glass panel 125 is disposed above the scanning unit 124 and a pressing unit 126is disposed above the glass panel 125. The document M is secured to the glass panel 125 by the pressing unit 126 during the scanning of the document M by the scanning unit 124 can.

The second transporting rollers 127 are formed of a pair of rollers contacting and facing each other and are disposed between the scanning unit 124 and a document discharge plate 128. The document discharge plate 128 receives the document M after it is transported by the second transporting rollers 127 to the scanning unit 124 to scan the document M.

The missing nozzle detection unit 130 scans test images T and compares the scanned test images T to data corresponding to a desired predetermined image. According to the compared result, if there are any missing portions (i.e., defects) within the test image T, the respective nozzle causing the missing portion may be detected. In other words, nozzles including defects that prohibit the nozzles from forming the test image that corresponds to the desired predetermined image are detected. The missing nozzle detection unit 130 also includes a pair of third transporting rollers 131 and a pair of fourth transporting rollers 132 that are disposed sequentially from the printing path S1 to the document reading path S2 along a missing nozzle detection path S3. Thus, the nozzle detection path S3 connects the printing path S1 and the document reading path S2. The third transporting rollers 131 and the fourth transporting rollers 132 are respectively formed of a pair of rollers contacting and facing each other.

Additionally, the missing nozzle detection unit 130 shares the scanning unit 124 of the image scanning unit 120 to scan the test image T, which is but one distinguishing feature of the present general inventive concept. In particular, the scanning unit 124 is shared by the missing nozzle detection unit 130 and the image scanning unit 120 so that either a test image T can be scanned or a document M can be read by the scanning unit 124. Accordingly, the scanning unit 124 can read the document M and scan the test image T to detect a missing nozzle of the plurality of nozzles of the array inkjet printhead as described above. Thus, since the image scanning unit 120 and the missing nozzle detection unit 130 share the scanning unit 124, the structure can be simplified and the overall size of the multi-functional peripheral device can be reduced.

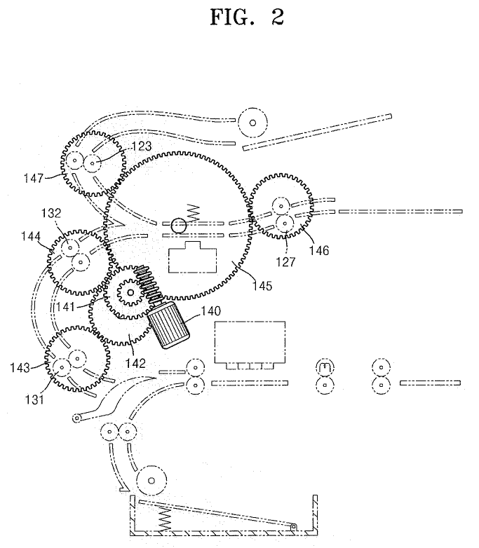

FIG. 2 illustrates the driving relationship of the transporting rollers illustrated in FIG. 1.

Referring to FIG. 2, the first transporting rollers 123, the second transporting rollers 127, the third transporting rollers 131, and the fourth transporting rollers 132 are all connected to one driving source 140 via a row of gears, and thus when the driving source 140 is actuated, each of the first, second, third, and fourth transporting rollers 123, 127, 131, and 132 are driven simultaneously.

In further detail, the first transporting rollers 123 and the second transporting rollers 127 are referred to as transporting rollers of a first group, and the third transporting rollers 131 and the fourth transporting rollers 132 are referred as transporting rollers of a second group. Here, the transporting rollers of the first group are meshed (i.e. interlocked) via a first intermediate gear 145 with a driving gear 141 is meshed with a driving source 140.The transporting rollers of the second group are meshed via a second intermediate gear 142 with the driving gear 141 that is meshed with the driving source 140.

Accordingly, the diameters of each of the transporting rollers of the first group are identical. Additionally, each of the transporting rollers of the first group are meshed with the intermediate gear 145 and thus are rotated at the same rotation speed. Also, the diameters of each of the transporting rollers of the second group are identical and the transporting rollers of the second group are meshed with the intermediate gear 142 and thus are rotated at the same rotation speed.

When the driving source 140 is actuated, the transporting rollers of a first group are rotated in a direction to transport the document M along the document reading path S2. Additionally, the transporting rollers of a second group are rotated in a direction to transport the print medium P on which a test image T is printed along the missing nozzle detection path S3.

The driving force transferring relationship is not limited to the above described structure, and though not illustrated in the drawings, in a general driving relationship, a driving force may be selectively applied to the transporting rollers of a first group using a conventional clutch as the driving force, thereby not actuating the transporting rollers of a second group. Alternatively, a driving force may be selectively applied to the transporting rollers of a second group, thereby not actuating the transporting rollers of a first group.

An image or test image T is printed on the print medium P along the printing path S1 and the document M is read along the document reading path S2. Since an image printing operation and document reading operation are well known in the art, description thereof will be omitted.

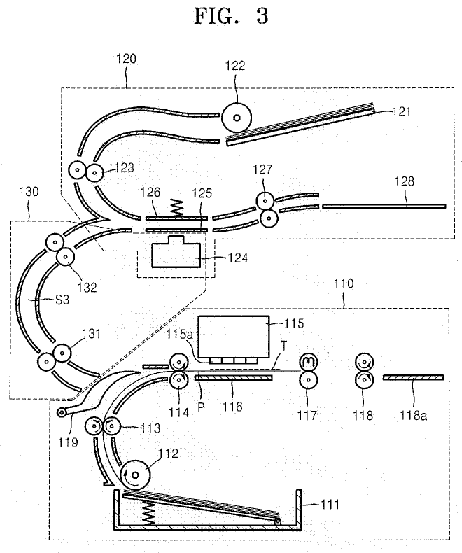

FIGS. 3 through 5 illustrate a reading operation of a test image T using the missing nozzle detection unit illustrated in FIG. 1.

Referring to FIG. 3, in a general printing operation, a print medium P loaded in the cassette 111 is picked up using the pickup roller 112 and is passed through the lower portion of the array inkjet printhead 115, in a forward direction, to form a test image T that corresponds to data associated with a desired image on the print medium P. After a test image T is formed on the print medium P, an end of the print medium P on which the test image T is printed should be meshed with the transporting roller 114 in order to transport the print medium P, on which the test image T is formed, in a reverse direction.

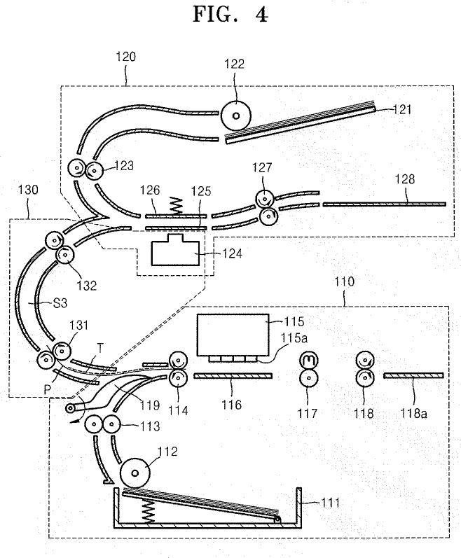

Referring to FIG. 4, the transporting rollers 114 are rotated in the opposite direction as compared to the direction illustrated in FIG. 3, and transport the print medium P, on which the test image T is printed, in a reverse direction, such that the print medium P with the test image T is fed from the printing path S1 toward the missing nozzle detection path S3. The guide unit 119 is then rotated clockwise with respect to FIG. 4 and guides the print medium P, on which the test image T is printed, toward the missing nozzle detection path S3.

As the third transporting rollers 131 and the fourth transporting rollers 132 formed on the missing nozzle detection path S3 are rotated, the first transporting roller 123 and the second transporting roller 127 are rotated at the same time according to the driving relationship illustrated in FIG. 2 and discussed above. Accordingly, the print medium P on which the test image T is printed is transported along the missing nozzle detection path S3.

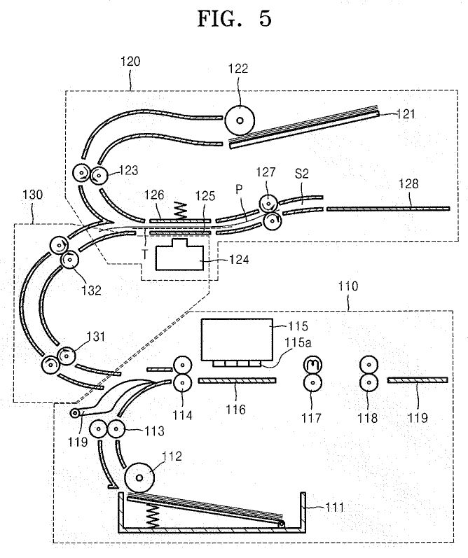

Referring to FIG. 5, the print medium P on which the test image T is printed enters the document reading path S2 and passes through the scanning unit 124 and thus the test image T is scanned or read. The print medium P from which the test image T is read is loaded on the document discharge plate 128 by the second transporting roller 127.

A controlling unit 100a compares the scanned test image T with data corresponding to a desired predetermined image, detects missing portions of the test image T that is read by the scanning unit 124 and accordingly determines if there are any missing nozzles or identifies any nozzle that may have defects as a result of the comparison. The nozzle defects are compensated for by performing a correction operation to solve the test image T defects. A conventional correction operation may be used as the correction operation of the present embodiment according to the detection of the missing or defective nozzles.

As described above, the multi-functional peripheral device according to the present general inventive concept has many advantages, as listed below, including:

First, image defects can be prevented by including the missing nozzle detection unit.

Second, as the missing nozzle detection unit and the image scanning unit share a scanning unit, the structure of the multi-functional peripheral device can be simplified and the overall volume thereof can be reduced.

Third, as the transporting rollers on the document reading path and the missing nozzle detection path are connected to and driven by the same driving source, the driving force transferring relationship of the transporting rollers can be simplified.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
an image forming unit formed above a printing path along which an image is formed on a print medium, including a plurality of nozzles to eject ink;
an image scanning unit formed adjacent the image forming unit and having a scanning unit formed on a document reading path transferring the document to read the document; and
a missing nozzle detection unit including a missing nozzle detection path that connects the printing path and the document reading path, and transports a print medium, on which a test image is formed by the image forming unit, to the document reading path via the missing nozzle detection path to scan the test image using the scanning unit,
wherein the image scanning unit and the missing nozzle detection unit share the scanning unit.

2. The image forming apparatus of claim 1, wherein the image forming unit further comprises a guide unit that is formed where the printing path and the missing nozzle detection path meet and guides the print medium that is picked up toward the inkjet printhead or guides the print medium on which a test image is printed on to the missing nozzle detection path.

3. The image forming apparatus of claim 2, wherein the image forming unit further comprises transporting rollers disposed between the guide unit and the inkjet printhead to be rotatably installed in both forward and reverse directions and to align the print medium.

4. The image forming apparatus of claim 1, wherein transporting rollers of a first group to transport a document are formed on the document reading path, and transporting rollers of a second group to transport the print medium on which a test image is printed are formed on the missing nozzle detection path,
wherein the transporting rollers of the first group and the transporting rollers of the second group are connected to an identical driving source and are driven accordingly.

5. An image forming apparatus comprising:
an image forming unit including a plurality of nozzles to eject ink to form a test image on a print medium according to data corresponding to a desired image;
an image scanning unit having a scanning unit to scan one or more documents including the print medium; and
a missing nozzle detection unit disposed between the image forming unit and the image scanning unit to feed the print medium to the image scanning unit to scan the test image from the print medium.

6. The image forming apparatus of claim 5, further comprising:
a controlling unit to compare the test image with the data corresponding to the desired image to detect a defective one of the plurality of nozzles.

7. The image forming apparatus of claim 6, wherein the controlling unit further
performs a correction operation to the corresponding defective one of the plurality of nozzles.

8. The image forming apparatus of claim 7, wherein the image forming unit further includes a rotatable guide unit and rotatable first and second transporting rollers to guide the print medium toward the plurality of nozzles in a first direction to form a test image thereon.

9. The image forming apparatus of claim 8, wherein the second transporting roller and the guide unit rotate in a second direction to guide the print medium with the test image formed thereon in a second direction towards a missing nozzle detection path of the missing nozzle detection unit.

10. The image forming apparatus of claim 9, wherein the second transporting roller aligns the print medium according to the missing nozzle detection path to transport the print medium along the missing nozzle detection path.

11. The image forming apparatus of claim 10, wherein the missing nozzle detection path includes a second group of transporting rollers formed thereon to transport the print medium with a test image formed thereon towards the scanning unit to scan the print medium with the test image formed thereon.

12. The image forming apparatus of claim 11, wherein the image scanning unit and the nozzle detection unit share the same scanning unit.

13. The image forming apparatus of claim 12, wherein the image scanning unit includes a first group of transporting rollers to transport the plurality of documents one by one along a document reading path to be scanned by the scanning unit.

14. The image forming apparatus of claim 13, wherein:
the first group of transporting rollers are formed along the document reading path and the second group of transporting rollers are formed along the missing nozzle detection path; and
the first group of transporting rollers and the second group of transporting rollers are simultaneously actuated by a driving source.

15. The image forming apparatus of claim 11, wherein a first end of the missing nozzle detection path connects to the document reading path and a second end of the missing nozzle detection path is disposed near the guide unit.

16. The image forming apparatus of claim 14, wherein:
the image scanning unit further comprises:
a glass panel disposed above the scanning unit, and
a pressing unit disposed above the glass panel; and
the first group of transporting rollers transport the plurality of documents one by one onto the glass panel and the pressing unit secures each of the documents to the glass panel when the document is scanned by the scanning unit.

17. The image forming apparatus of claim 14, wherein the first group of transporting rollers are meshed with a driving gear and the driving gear is meshed with the driving source via a first intermediate gear.

18. The image forming apparatus of claim 17, wherein the second group of transporting rollers are meshed with the driving gear and the driving gear is meshed with the driving source via a second intermediate gear.

19. The image forming apparatus of claim 18, wherein when the driving source is actuated, the first group of transporting rollers are rotated to transport the one or more documents along the document reading path, and the second group of transporting rollers are rotated to transport the print medium with a test image formed thereon along the missing nozzle detection path.
